(19) United States
(12) Patent Application Publication
(10) Pub. No.: US 2018/0252065 A1
(43) Pub. Date: Sep. 6, 2018

(54) WIRELESS CONTROL SYSTEM FOR SUBSEA DEVICES

(71) Applicant: Edward Ryan Hemphill, Cypress, TX (US)

(72) Inventor: Edward Ryan Hemphill, Cypress, TX (US)

(21) Appl. No.: 15/910,904

(22) Filed: Mar. 2, 2018

Related U.S. Application Data
(60) Provisional application No. 62/466,143, filed on Mar. 2, 2017.

(51) Int. Cl. E21B 33/035; E21B 41/00; E21B 33/064; E21B 47/00; H04B 1/74

(52) U.S. Cl. CPC E21B 33/0355; E21B 41/0007; H04B 1/745; E21B 47/0001; E21B 33/064

(57) ABSTRACT

A system for communicating with subsea devices having a subsea device with a first control system in communication by a physical connection with a control site; and a second control system in communication by a physical connection with the subsea device. The second control system has no physical connection with the control site, and the second control system is configured to facilitate high-speed wireless communication with the subsea device.

### CROSS-REFERENCE TO RELATED APPLICATIONS

This application claims benefit, under 35 U.S.C. § 119, of U.S. Provisional Application Ser. No. 62/466,143 filed on Mar. 2, 2017 and entitled “Wireless Control System for Subsea Devices.” The disclosure of this U.S. Provisional Application is incorporated herein by reference in its entirety.

### BACKGROUND

A drilling rig is typically defined as the machine used to drill a wellbore. In onshore operations, the rig includes virtually everything except living quarters. Major components of the rig include the mud tanks, the mud pumps, the derrick or mast, the drawworks, the rotary table or topdrive, the drillstring, the power generation equipment and auxiliary equipment. Offshore, the rig includes the same components as onshore, but not those of the vessel or drilling platform itself. The rig is sometimes referred to as the drilling package, particularly offshore. Off-shore drilling may be performed from a submersible rig, jack-up rig, semisubmersible rig, or drillship depending on the depth of the water through which the drilling rig is drilling. The drilling rig is connected to the seabed via the drill string, along which a variety of components may be mounted. Further, control of such components, i.e., subsea devices, are typically performed by a physical wired connection to control systems on the drilling rig.

Additionally, in one or more embodiments, an oil platform, offshore platform, or oil rig is a large structure with facilities to drill wells, to extract and process oil and natural gas, or to temporarily store product until it can be brought to shore for refining and marketing. In many cases, the platform contains facilities to house the workforce as well. Depending on the circumstances, the platform may be fixed to the ocean floor, may consist of an artificial island, or may float. Remote subsea wells may also be connected to a platform by flow lines and by umbilical connections. These sub-sea solutions may consist of one or more subsea wells, or of one or more manifold centers for multiple wells.

As seen in FIG. 1, various types of oilfield rigs are shown such as a land rig 10. Additionally, a fixed platform 11 is built on concrete or steel legs, or both, anchored directly onto a seabed 17, supporting a deck with space for drilling rigs, production facilities and crew quarters. The fixed platform 11 is, by virtue of its immobility, designed for very long term use. Furthermore, a compliant tower 12 consists of slender, flexible towers and a pile foundation supporting a conventional deck for drilling and production operations. The compliant tower 12 is designed to sustain significant lateral deflections and forces at deeper depths than the fixed platform 12. Also seen in FIG. 1, a semi-submersible platform 13 has hulls (columns and pontoons) of sufficient buoyancy to cause the structure to float near a surface 15 of a body of water 16, but of weight sufficient to keep the structure upright. The semi-submersible platform 13 can be moved from place to place and can be ballasted up or down by altering the amount of flooding in buoyancy tanks. Also the semi-submersible platform 13 is generally anchored by combinations of chain, wire rope or polyester rope, or both, during drilling and/or production operations, though they can also be kept in place by the use of dynamic positioning. In one or more embodiments, a drillship 14 is a maritime vessel that has been fitted with drilling apparatus. It is most often used for exploratory drilling of new oil or gas wells in deep water but can also be used for scientific drilling. Most drillships 14 are outfitted with a dynamic positioning system to maintain position over a well.

In one specific example of a subsea component, a blowout preventer (“BOP”) is a large valve or a series of large valves at the top of a well that may be closed, if the drilling crew loses control of formation fluids. By closing this valve (usually operated remotely via hydraulic actuators), the drilling crew usually regains control of the reservoir, and procedures can then be initiated to increase the mud density until it is possible to open the BOP and retain pressure control of the formation. BOPs come in a variety of styles, sizes and pressure ratings. Some can effectively close over an open wellbore, some are designed to seal around tubular components in the well (drill pipe, casing, or tubing) and others are fitted with hardened steel shearing surfaces that can actually cut through drill pipe. Typically, in subsea conditions, a BOP stack is used which is a set of two or more BOPs used to ensure pressure control of a well are controlled

BOP stacks are typically controlled by running one or more (typically two) multiplexed (MUX) control cables. The MUX control cables have a plurality of communication and power conducting wires and/or fiber optics bundled inside. The MUX cables have historically been labeled the Blue cable and the Yellow cable. Typically, the MUX cables are run down the outer diameter of the drilling riser and are usually connected to the drilling riser at certain distance intervals. Furthermore, the MUX cables connect the surface drilling control system located on a fixed (supported by the ocean floor) or floating drilling vessel to the subsea control pods (historically referred to as the Blue and Yellow MUX pods) located on the BOP stack. Thus, enabling the MUX pods to receive or send commands or signals to and from the surface control system through the MUX cable. The MUX pod(s) distribute control fluids to operate the appropriate function corresponding to the commands or signals. Some of the functions include safety critical failure functions such as shear rams close functions that would be used as a final attempt to stop uncontrolled flow of hydrocarbons from the well (a blowout).

However, an issue with the Blue and Yellow MUX cables occurs if the drilling riser breaks. Because the Blue and Yellow MUX cables run down the drilling riser, the cables break or pull away from the BOP stack or drilling vessel when the drilling riser breaks. Additionally, if there is a catastrophic event on the drilling vessel that causes a permanent disruption to communication between the BOP stack and the surface control system, there is no control of the BOP system. Thus, a second communication system must be used. All three of these issues occurred with the DeepWater Horizon disaster in 2010. For critical applications, there are some technologies that are used as a backup to the MUX cables in the event they are broken.

Typical backup communication systems consist of using a subsea remotely operated vehicle (ROV) to operate the functions of the acoustic pods. The ROV necessary to perform this function is required to have fluid pumping capabilities to interface with the BOP stack.

Another second communication system consists of a remotely seabed-mounted skid that can be attached to the BOP stack to provide an alternate controlling mechanism such as an acoustic connection. Such acoustic systems are wireless, but are severely limited on communication bandwidth and speed. Many of these acoustic systems operate at single, double, or triple digit bits per second, while the primary MUX cables operate at kilobits, megabits, or gigabits per second. Thus, current second acoustic communication systems can realistically only control some of the BOP functions and need remote interfaces to accomplish the communication.

Also, there are other forms of wireless communication through water, such as WiFi or FM/AM frequencies. However, these wireless technologies (like acoustics) are typically slow when attempted through water. Moreover, current wireless technologies (like acoustics) are especially slow over large distances, such as in deep water, and are subject to disruption and distortion due to currents, changes in densities of the water due to temperature and salinity, and can affect or be affected by sea animal or mammal communications. The longer the distance through water, the more challenged these wireless communications are with respect to robustness and speed.

### SUMMARY

One or more embodiments of the present invention may address one or more of the challenges faced by conventional primary or backup communication systems and/or may provide advantages over conventional primary or backup communication systems, as will be apparent to one of ordinary skill.

In one aspect, embodiments disclosed herein relate to a system for communicating with subsea devices and may include a subsea device; a control site; and a control system having no physical connection with a control site, and wherein the control system is configured to facilitate high-speed wireless communication between the control site and the subsea device.

In another aspect, embodiments disclosed herein relate to a system for communicating with subsea devices and may include a subsea device with a first control system in communication by a physical connection with a first control site; and a second control system in communication by a physical connection or wirelessly with the subsea device, wherein the second control system has no physical connection with the first control site, and wherein the second control system is configured to facilitate high-speed wireless communication with the subsea device.

In another aspect, embodiments disclosed herein relate to a method for communicating with subsea devices including communicating with a subsea device with a first control system in communication by a physical connection with a first control site; communicating wirelessly at high-speeds to a second control system in communication by a physical connection or wirelessly with the subsea device; controlling the subsea device with the second control system, wherein the second control system has no physical connection with the first control site.

In another aspect, embodiments disclosed herein relate to a system for communicating with subsea devices and may include a subsea device with a first control system in communication by a physical connection with a first control site; and a second control system in communication by a physical connection with a cable reel or any other type of device that could serve to tether the buoy or other buoyant device to a given location that may or may not be located on the seafloor, wherein the cable reel is configured to facilitate underwater wireless communication with the subsea device, wherein the second control system has no physical connection with the first control site, and wherein the second control system is configured to facilitate high-speed wireless communication with the subsea device.

In another aspect, embodiments disclosed herein relate to a method for communicating with subsea devices including communicating with a subsea device with a first control system in communication by a physical connection with a first control site; communicating wirelessly at high-speeds to a second control system in communication by a physical connection with a cable reel, wherein the cable reel wirelessly communicates underwater with the subsea device; controlling the subsea device with the second control system, wherein the second control system has no physical connection with the first control site.

In another aspect, embodiments disclosed herein relate to a system for communicating with subsea devices including a subsea device comprising a control system having no physical connection with a control site which could be any apparatus such as a drilling rig, boat, drone, airplane, satellite, fixed platfoim, office or office building, or any other device or structure on land or offshore, and wherein the control system is configured to facilitate high-speed wireless communication between the control site and the subsea device.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF DRAWINGS

FIG. 1 is a perspective view of rig types and operating environments.

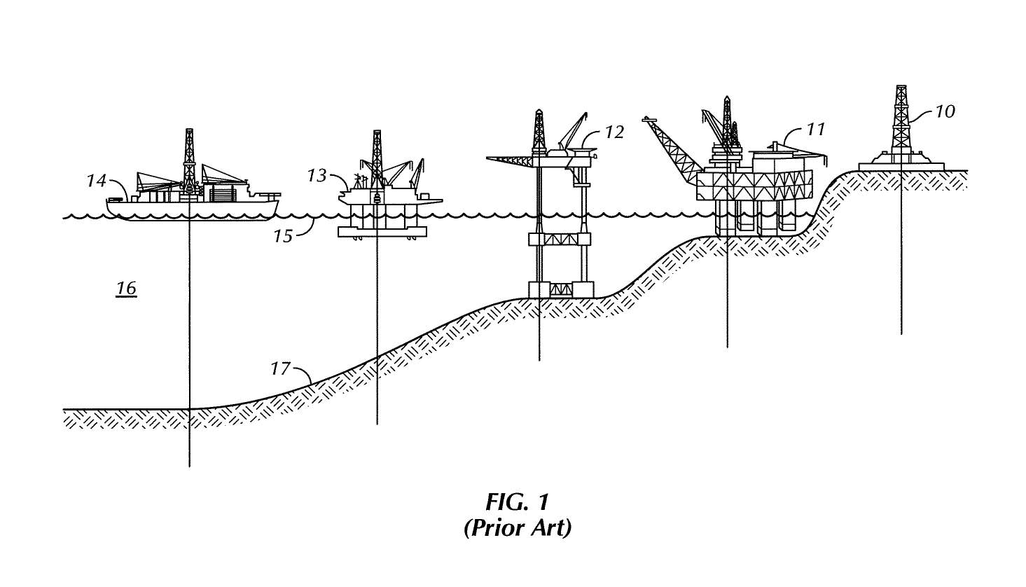

FIG. 2 is a block diagram of a system for communicating with subsea devices in accordance with one or more embodiments of the present disclosure.

FIG. 3 is a block diagram of a system for communicating with subsea devices in accordance with one or more embodiments of the present disclosure.

FIG. 4 is a block diagram of a system for communicating with subsea devices in accordance with one or more embodiments of the present disclosure.

FIG. 5 is a perspective view of a system for communicating with subsea devices in accordance with one or more embodiments of the present disclosure.

FIG. 6 is a perspective view of a system for communicating with subsea devices in accordance with one or more embodiments of the present disclosure.

FIG. 7 is a perspective view of a system for communicating with subsea devices in accordance with one or more embodiments of the present disclosure.

FIG. 8 is a perspective view of a system for communicating with subsea devices in accordance with one or more embodiments of the present disclosure.

### DETAILED DESCRIPTION

Embodiments of the present disclosure are described below in detail with reference to the accompanying figures. Like elements in the various figures may be denoted by like reference numerals for consistency. Further, in the following detailed description, numerous specific details are set forth in order to provide a more thorough understanding of the claimed subject matter. However, it will be apparent to one having ordinary skill in the art that the embodiments described may be practiced without these specific details. In other instances, well-known features have not been described in detail to avoid unnecessarily complicating the description.

Further, embodiments disclosed herein are described with terries designating a control site (first or second) in reference to an offshore rig, but any tears designating rig type or structure should not be deemed to limit the scope of the disclosure. For example, embodiments of the disclosure may be used on a drilling rig. It is to be further understood that the various embodiments described herein may be used in various structures or rig sites, such as but not limited to a land rig, offshore platform or vessel, boat, satellite, drone, airplane, helicopter, submarine, land-based building or office, offshore based building or office, any other device or structure (on land or offshore), or any combination thereof that could be used to communicate with a control system or subsea device. Additionally, the control site may be in other environments, such as rig installation, work-over rigs, fracking installation, well-testing installation, oil and gas production installation, completion operations or any other device or structure that could be used to control or operate subsea operations without departing from the scope of the present disclosure. The embodiments are described merely as examples of useful applications, which are not limited to any specific details of the embodiments herein. Additionally, one skilled in the art will appreciate the present application is not limited to oil and gas industry and may be used in other industries.

Further, embodiments disclosed herein are described with terms designating in reference to a subsea device, but any terms designating should not be deemed to limit the scope of the disclosure. For example, embodiments of the disclosure may be used on one or more blowout preventer(s) (BOP) or BOP stack(s). It is to be further understood that the various embodiments described herein may be used with various types of subsea devices, including but not limited to one or more subsea control pods of the BOP stack, a subsea tree, a wellhead, a compression system, an artificial lift system, any other system or device located below a surface of a body of water (i.e., ocean), or any combination thereof without departing from the scope of the present disclosure. The embodiments are described merely as examples of useful applications, which are not limited to any specific details of the embodiments herein.

In accordance with one or more embodiments of the present invention, a system for communicating with subsea devices is provided. The system includes a subsea device that may include a control system in communication by a physical connection with a first control site; and a second control system in communication by a physical connection or wirelessly with the subsea device. The second control system has no physical connection with the first control site, and the second control system is configured to facilitate wireless communication with the subsea device.

One or more embodiments of the present invention, the second control system may make use of one or more deployed wireless communication structures (such as floating buoys) located a distance away from the first control site that are connected to the subsea devices' (BOP stack) control interface systems (pods) by a physical connection, hardline, umbilical or cable similar, if not identical, to, but not limited to, MUX cables used to connect the pods to the drilling vessel. These physical connections, hardlines, unbilicals, cables, or MUX cables are any devices that can transmit power or communications or any combination thereof between devices. For example, the form of com may include but not limited to pressure pulses (air or liquid), electric lines for communication over power lines, copper wires, fiber optics, or any combination thereof. Additionally, the second control system uses high-speed wireless technologies such as but not limited to BluetoothTM, WiFi, cellular network, FM/AM frequencies, and other high-speed wireless technologies known to those skilled in the art.

In the context of this application, the “high-speed” wireless communication of the second communication system may be defined as wireless communications at a speed of at least 100 kilobits per second. In one or more embodiments, the high-speed wireless communications may be at a speeds on the order of megabits per second, gigabits per second, or terabits per second or even higher depending on the environment in which the system is employed and the types of wireless transmission equipment being used. Furthermore, in one or more embodiments, the high-speed wireless technologies can be defined as being at such a speed so as to facilitate control of the entire subsea devices (e.g., BOP pods) at speeds similar to the speeds of the physical connection to the control site (e.g., primary drilling vessel mounted system). Furthermore, in one or more embodiments, the high-speed wireless communications may be at speeds that exceed the communication speeds of the physical connection to the primary drilling vessel mounted system depending on the type of physical connection being employed.

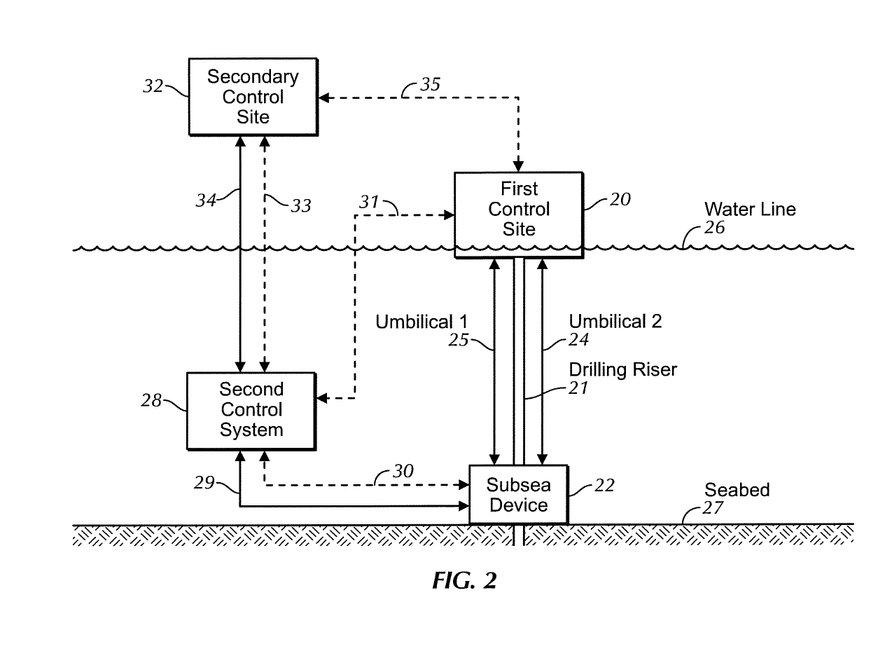

As shown in FIG. 2, in one or more embodiments, a first control site 20 (such as an offshore platform) is directly connected, by a drilling riser 21, to a subsea device 22. Additionally, as seen by umbilical 1 (25) and umbilical 2 (24), signals can be sent back and forth from the first control site 20 to the subsea device 22 to control the subsea device 22 on a seabed 27. If the umbilicals (24, 25) are damaged or communication is interrupted, the first control site 20 can wirelessly 31 send signals to a second control system 28 that may be located above or below the water line to control the subsea device 22. The second control system 28 can send signals to the subsea device 22 by a physical connection (e.g., a hardline 29) or wirelessly communicate 30 to control the subsea device 22. For example, the hardline 29 may contain electrical wiring to communicate over power lines, fiber optics, copper wires, MUX cables, pressure pulses (air or liquid), or other method of communication through a physical cable that can carry any type of communication signal. One skilled in the art will appreciate how second control system 28 may be submerged or float at a waterline 26 (i.e., a surface of a body of water). In one or more embodiments, the second control system 28 may be attached via the physical connection (e.g., the hardline 29) or be in communication wirelessly 30 to the subsea device 22. Still referring to FIG. 2, a secondary control site 32, separate of the first control site 20, may be used to wirelessly communicate 33 or be directly connected 34 to the second control system 28 to control the subsea device 22. Additionally, the first control site 20 may wirelessly communicate 35 with the secondary control site 32. One skilled in the art will appreciate how the first control site 20 and secondary control site 32 may be co-located. Further, the first control site 20 and/or secondary control site 32 may also be a first control system or in communications with the first control system to facilitate communications to and from the subsea device 22. Additionally, as described above, the first control site 20 and the secondary control site 32 may be, but not limited to, another offshore platform, boat, satellite, drone, airplane, helicopter, submarine, land-based structure, offshore based structure, or any other device or structure that could be used to control or operate subsea operations (and communicate 33, 34 to the second control system 28).

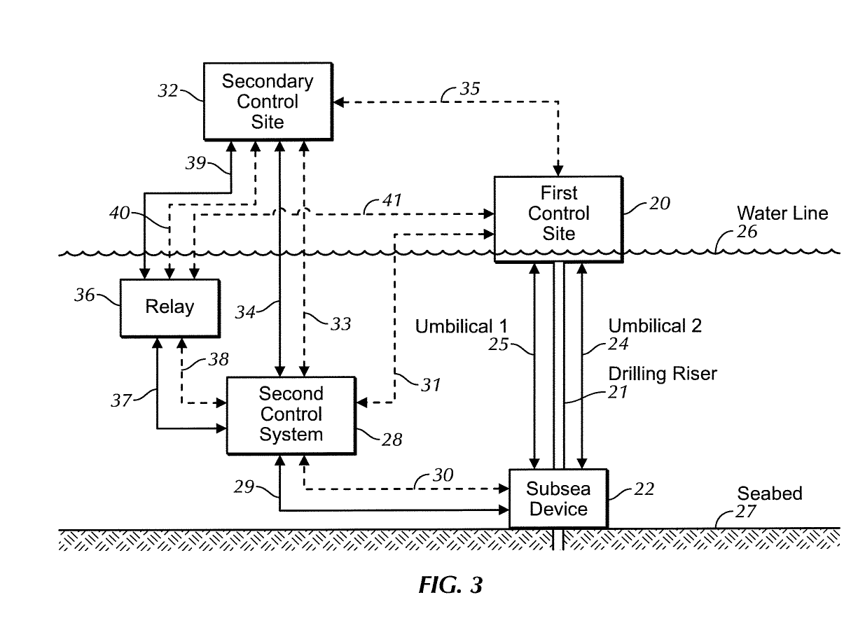

Now referring to FIG. 3, in one or more embodiments, a first control site 20 (such as an offshore platform) is directly connected, by a driller riser 21, to a subsea device 22. Additionally, as seen by umbilical 1 (25) and umbilical 2 (24), signals can be sent back in forth from the first control site 20 to the subsea device 22 to control the subsea device 22 on a seabed 27. If the umbilicals (24, 25) are damaged or communication is interrupted, the first control site 20 can wirelessly 31 send signals to a second control system 28 to control the subsea device 22. The second control system 28 can send signals to the subsea device 22 by a physical connection (e.g., a hardline 29) or wirelessly communicate 30 to control the subsea device 22. Still referring to FIG. 3, a secondary control site 32, separate from the first control site 20, may be used to wirelessly communicate 33 or be directly connected 34 with the second control system 28 to control the subsea device 22. Additionally, the first control site 20 may wirelessly communicate 35 with the secondary control site 32. One skilled in the art will appreciate how the first control site 20 and/or secondary control site 32 may also be a first control system or in communications with the first control system to facilitate communications to and from the subsea device 22. As describe above, the first control site 20 and the secondary control site 32 may be, but not limited to, another offshore platform, boat, satellite, drone, airplane, helicopter, submarine, land-based structure, offshore based structure, or any other device or structure that could be used to control or operate subsea operations (and communicate 33, 34 to the second control system 28). Additionally, a relay 36, which is submerged below the waterline 26, may be included to either directly 37 or wirelessly 38 communicate with the second control system 28. Further, the relay 36 may send and receive signals wirelessly 41 from the first control site 20 to transmit them to and from the second control system 28. In one or more embodiments, the secondary control site 32 may directly 39 or wirelessly 40 communicate with the relay 36 to send and receive signals to the second control system 28. One skilled in the art will also appreciate that the relay 36 or the second control system 28 may be located above or below the water line and may be located on land or offshore.

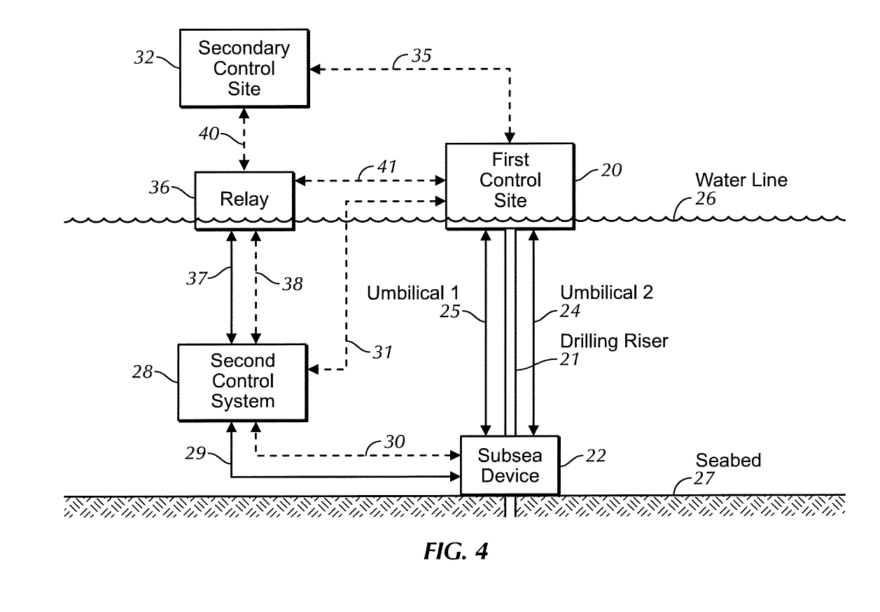

Now referring to FIG. 4, in one or more embodiments, a first control site 20 (such as an offshore platform) is directly connected, by a driller riser 21, to a subsea device 22. Additionally, as seen by umbilical 1 (25) and umbilical 2 (24), signals can be sent back in forth from the first control site 20 to the subsea device 22 to control the subsea device 22 on a seabed 27. If the umbilicals (24, 25) are damaged or communication is interrupted, the first control site 20 can wirelessly 31 send signals to a second control system 28 to control the subsea device 22. The second control system 28 can send signals to the subsea device 22 by a physical connection (e.g., a hardline 29) or wirelessly communicate 30 to control the subsea device 22. Still referring to FIG. 4, a secondary control site 32, separate from the first control site 20, may be used to wirelessly communicate 40 to a relay 40, which in turn sends the signals to the second control system 28 to control the subsea device 22. Additionally, the first control site 20 may wirelessly communicate 35 with the secondary control site 32. One skilled in the art will appreciate how the first control site 20 and/or secondary control site 32 may also be a first control system or in communications with the first control system to facilitate communications to and from the subsea device 22. As describe above, the first control site 20 and the secondary control site 32 may be, but not limited to, another offshore platform, boat, satellite, drone, airplane, helicopter, submarine, land-based structure, offshore based structure, or any other device or structure that could be used to control or operate subsea operations (and communicate 40 to the relay 36). Additionally, the relay 36, which is floating at the waterline 26, may either be hardline 37 or wirelessly 38 communicate with the second control system 28. Furthermore, the relay 36 may send and receive signals wirelessly 41 from the first control site 20 to transmit them to and from the second control system 28. One skilled in the art will also appreciate that the relay 36 or the second control system 28 may be located above or below the water line and may be located on land or offshore.

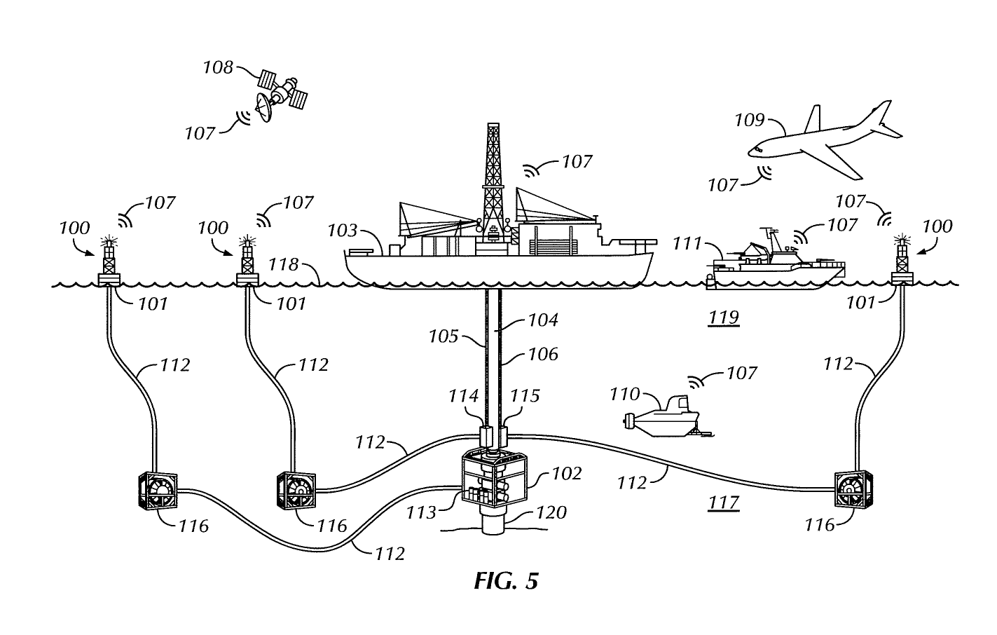

Referring to FIG. 5, in one or more embodiments, a drilling vessel 103 is positioned in a body of water 119. The drilling vessel 103 has a drilling riser 104 extending downwards from the drilling vessel 103 to a subsea device that extends into a sea floor 117. For example, but not limited to, the subsea device may be a BOP stack 102 that sits on a wellhead 120 that extends into on the sea floor 117 and the drilling riser 104 connects to the BOP stack 102. On the BOP stack 102 are auxiliary pod 113, a blue MUX pod 114, and a yellow MUX pod 115 which provide communications to the BOP stacks 102. Furthermore, a blue MUX cable 105 and a yellow MUX cable 106 extend from the drilling vessel, on the sides of the drilling riser 104, to connect to the blue MUX pod 114 and the yellow MUX pod 115 respectively. Thus, through the blue MUX cable 105 and the yellow MUX cable 106, the drilling vessel 103 is able to communicate to the BOP stack 102. It is further envisioned that electrical wiring to communicate over power lines, fiber optics, copper wires, pressure pulses (air or liquid), or other method of communication through a physical connection that can carry any type of communication signal may be used instead of the MUX cables 106, 105 without departing from the scope of the present disclosure.

As shown in FIG. 5, in one or more embodiments, a second control system 100 serves either as a primary or a backup communication system of the BOP stack 102 located away from and may not be physically connected to the drilling vessel 103. Furthermore, the second control system 100 may be mounted on a buoy 101 or apparatus to maintain buoyancy at or around a surface 118 of the body of water 119. By doing so, the second communication system integrity is protected to operate should the drilling vessel 103 drive off location or have a catastrophic event, such as in the case of the Deepwater Horizon or the Pipe Alpha event. Furthermore, a sensor can be mounted on the buoy 101 together with a sensor configured to detect a loss of communication between the drilling rig 103 and the BOP stack 102. FIG. 5 shows the use of three second control systems 100, but one skilled in the art will appreciate how the present disclosure is not limited to three and can have a plurality of second control systems 100 or only one second control system 100. Additionally, if a drilling riser 104 should break and fall to the ocean floor or a MUX cables (a blue MUX cable 105 and a yellow MUX cable 106) sever, a wireless communication 107 can occur from the drilling vessel 103 to the second control system 100 as the backup communication device to the BOP stack 102.

Furthermore, one skilled in the art will appreciate how the present discourse in one or more embodiments can be used as the primary control system as well. The wireless communications 107 communicating with the second control system 100 are not limited to just the drilling vessel. In any event, a different drilling vessel (not shown) other than the one deploying the BOP stack 102, a satellite 108, an airplane 109, a drone (not shown but air or water), submarine or ROV 110, a boat 111, or any other mobile unit or fixed unit located offshore, on land, in the sky, in outer space, or any other device or structure that could be used to control or operate subsea operations within wireless communication range of the second control system 100 may wirelessly communicate with the second control system 100.

Still referring to FIG. 5, in one or more embodiments, the wireless technologies that currently exist can communicate in the megabit to gigabit range over long or short distances. A wireless communication speed when combined with a physical connection, such as, but not limited to, hardlines 112, running from the buoys 101 to the BOP stack 102 allows for remote control of the BOP stack 102 at significantly higher communication speeds than acoustic or other wireless communication systems through water can currently provide. The hardlines 112 can be copper wires or fiber optic cables similar to or just like the MUX cables (105 and 106). The hardlines may also be able to communicate pressure pulses (air or liquid), electrical wiring to communicate over power lines, or any other type of signal that can transmit any type of communication. Additionally, the hardlines 112 have an apparatus or a cable reel 116 which is anchored to the sea floor 117 and can control the length of the physical connection (i.e. hardlines 112). The cable reel may be any device that could serve to tether the buoy or other buoyant device to a given location that may or may not be located on the seafloor. One skilled in the art will appreciate how the hardlines 112 can connect to an auxiliary pod 113, a blue MUX pod 114, or a yellow MUX pod 115. This enables the safety of critical functions to be operated efficiently and the ability to control all functions and receive feedback signals just as if the BOP stack 102 was being controlled by the drilling vessel's 103 first BOP control system (i.e., a control system such as the auxiliary pod 113, blue MUX pod 114, or yellow MUX pod 115).

In addition to communications, the BOP MUX control pods (113, 114, and 115) receive electrical power from the drilling vessel 103 through the MUX cables (105 and 106) attached to the sides of the drilling riser 104, and thus another problem arises if the primary communication and power from the drilling vessel to the BOP through the MUX cables that are attached to the drilling riser are severed or disconnected. Therefore, battery backups and/or uninterruptable power supplies (UPS) can be mounted onto the buoys 101 to provide backup power to the BOP stack 102, if needed. The buoy could also be any type of buoyant device. In one or more embodiments, the battery backups can be charged from the drilling vessel 103 through the MUX cables (105 and 106) and the hardlines 112 under normal operating conditions. Additionally, solar panels may be mounted on the buoys 101 as may any other power generating technology including wave and/or wind power generation to provide an additional power source. In the event the drilling vessel 103 is not able to communicate or power the BOP stack 102 mounted control pods (113, 114, and 115), the second control system 100 on the buoy 101 would provide the power to the BOP stack 102 mounted control pods (113, 114, and 115). Additionally, the boat 111 or ROV 110 may attach a physical connection to the second control system100 to facilitate power and communications.

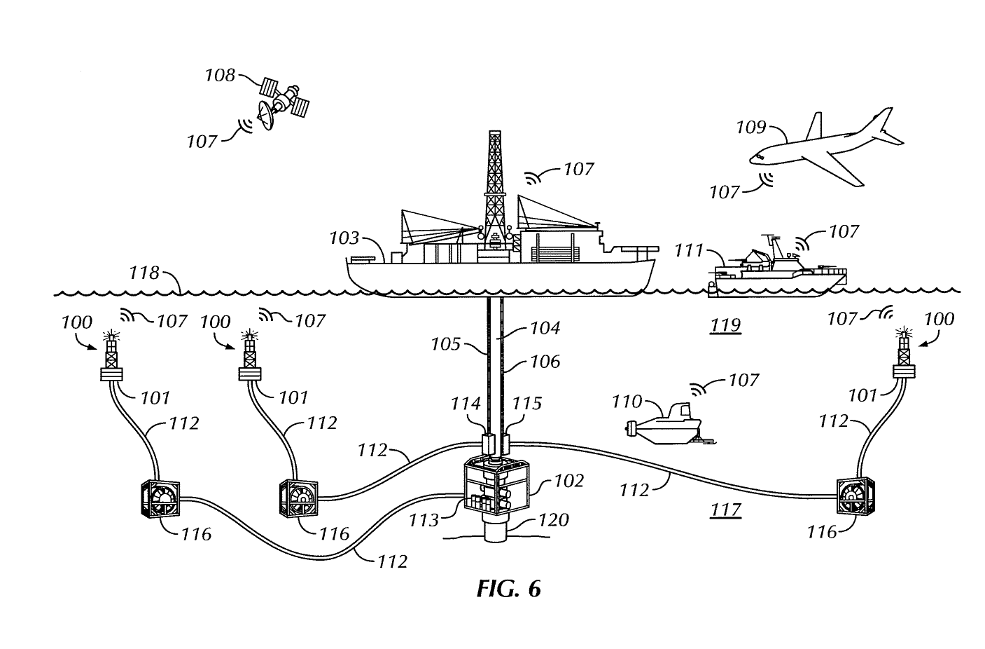

In one or more embodiments, the second control system 100 for communicating with subsea devices can be used to help improve the speed and robustness of through water wireless communications if an underwater communication system is desired to be used. As seen by FIG. 6, the buoy 101 does not have to float on the surface 118 of the body of water 119. The buoy 101 can be submerged a distance below the surface 118. Submerging the buoy 101 would lessen a distance that the wireless communications 107 would have to travel through the water which may improve the quality, robustness, and the speed of the underwater wireless communication signals while maintaining a distance away from the drilling vessel 103 in case of a loss of communications event as described above. Additionally, the buoys 101 may be submerged shallow enough to enable wireless communication to the submerged buoy 101 by a satellite 108, airplane 109, helicopter, drone, or any other device or structure located offshore, on land, in the sky, or in outer space.

In one or more embodiments, the buoy 101 can be deployed prior to the start of the well or the buoy 101 can be sitting on the sea floor 117 and deployed only in an emergency situation. The buoy 101 can be triggered to deploy by a system such as the autoshear or deadman circuits on the BOP stack 102, by another signal such as a simple through water wireless signal, the sensor on the buoy 101 for detecting a loss of communication between the drilling rig 103 and the BOP stack 102, or by an ROV. Additionally, the buoy 101 can be motorized or not, position controlled remotely or not, and may be manned or unmanned. One skilled in the art will appreciate how the buoy 101 can be a boat, boat type drone, or any other floating structure and can stay on location with the assistance of a guidance positioning system (GPS) located with motorized propulsion, or simply tethered to the bottom of the ocean.

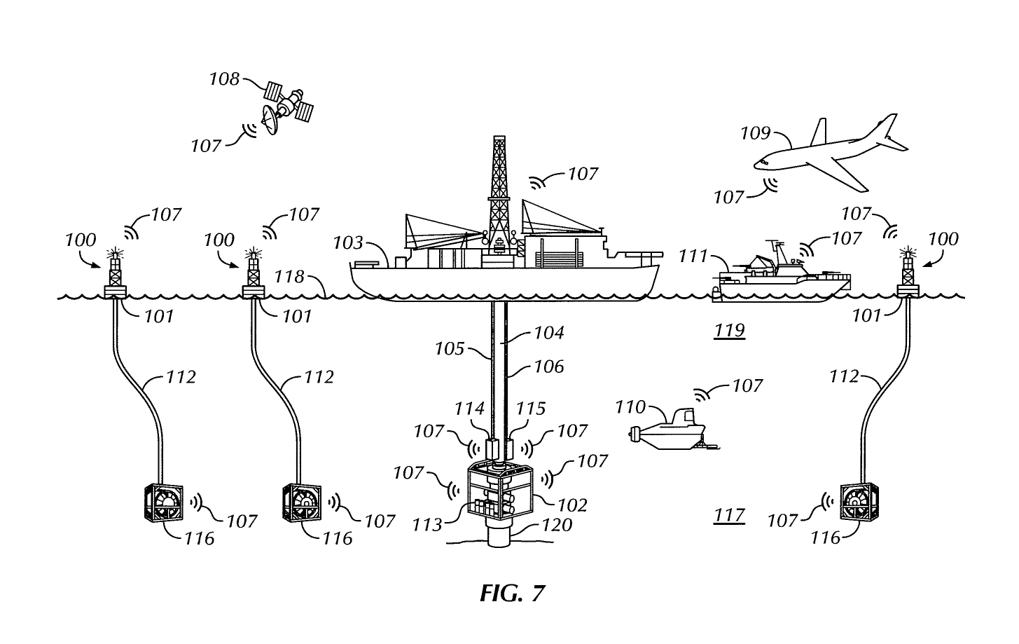

In one or more embodiments, the buoy 101 can send and receive wireless communications 107 through the air and transmit the signal to the underwater buoy anchors or cable reels 116. As seen by FIG. 7, the cable reel 116 can wirelessly communicate 107 underwater with the BOP stack 102 or one or more pods (113, 114, and 115) located on the BOP stack 102. Furthermore, the cable reels 116 can be located closer to the BOP stack 102 or pods (113, 114, and 115) on the bop stack 102 to limit the communication transmission distance through water between each wireless communication 107. By positioning the cable reel 116 closer to the BOP stack 102, the speed, robustness, and quality of the wireless communication 107 is improved. Additionally, this would eliminate any hardwired connection directly to the BOP stack 102 or the drilling vessel 103.

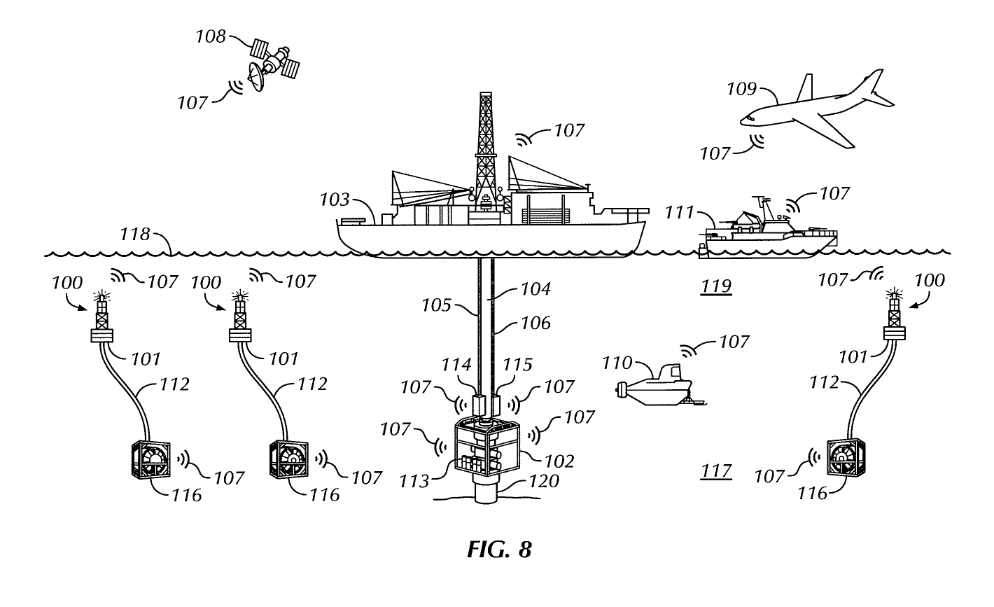

As shown in FIG. 8, in one or more embodiments, shows the buoy 101 can be submerged just below the surface 118 of the body of water 119 and transmit wirelessly through water to and from the drilling vessel 103 or any other type of vessel or structure on the surface. From the buoy 101, the communication can be transmitted to the buoy anchors or cable reels 116 on the sea floor 117 located close to the BOP stack 102. Additionally, the underwater anchors or cable reels 116 can transmit and receive data to and from the BOP stack 102 with wireless communications 107 under water. As stated above, this reduces the distance the wireless communications 107 have to travel through the water to the BOP stack 102 and to the drilling vessel 103 or other devices including but not limited to satellites 108, boats 111, and/or airplanes 109. By reducing the amount of water the wireless communications 107 has to travel through, the wireless communications 107 can become faster, more robust, or more reliable.

One skilled in the art will appreciate how second control system 100 is not limited to controlling the BOP stack 102, but can control any subsea device or system requiring communications such as subsea trees, manifolds, compression system, artificial lift system, or any other type of system mounted below the water's surface that requires a controls interface. Furthermore, one skilled in the art will appreciate how the drilling vessel 103 is not limited to a drillship and may be any type of rig, vessel, offshore structures, or any other device offshore or on land. Additionally, one skilled in the art will appreciate how the second control system 100 can be configured for a land rig application.

Furthermore, methods and systems of the present disclosure may include the use of one or more deployed wireless communication structures (such as floating buoys) located a distance away from the control site, such as in FIGS. 2-8. Because the methods and systems may apply to any of the embodiments, reference numbers are not stated to avoid confusion of the numbering between the different embodiments.

In some embodiments, a system for communicating with subsea devices may include a subsea device including a first control system in communication by a physical connection with a first control site (i.e. drilling rig); and a second control system in communication by a physical connection with the subsea device, wherein the second control system has no physical connection with the first control site, and wherein the second control system is configured to facilitate high-speed wireless communication with the subsea device. Additionally, the second control system may include a sensor for detecting a loss of communication between the first control site and the subsea device, and wherein the second control system is configured to facilitate high-speed wireless communication with the subsea device when a loss of communication between the first control site and the subsea device is detected. The second control system may be a floatation device for maintaining buoyancy and an independent power source for powering operations of the second control system and subsea device. Further the second control system may include a sensor for detecting a loss of communication between the first control site and the subsea device; and a floatation device for maintaining buoyancy, wherein the second control system is deployed when a loss of communication between the first control site and the subsea device is detected, and wherein the second control system is configured to facilitate high-speed wireless communication with the subsea device when a loss of communication between the first control site and the subsea device is detected. The subsea device is blowout preventer stack, a subsea tree, a compression system, or artificial lift system and the second control system may have a second power source for the blowout preventer stack, a subsea tree, a compression system, or an artificial lift system. The second power source may be one or more batteries, one or more solar panels, one or more wind power generators, one or more wave power generators, or any other power generating technology for the backup power. Further, the physical connection between the control system and the subsea device may include one or more multiplexed (MUX) control cables connecting the rig to one or more subsea control pods of the blowout preventer (BOP) stack, the subsea tree, the compression system, the artificial lift system, or any other system located below the surface of the ocean. The one or more multiplexed control cables extending along an outer diameter of a drilling riser of the drilling rig. The second control system may be a buoy capable of floating on a surface of a body of water and may be a motorized boat and can be positioned remotely. Additionally, the buoy may be submersible and a motorized boat and can be positioned remotely. Furthermore, the physical connection between the second control system and the subsea device may include copper wires or fiber optic cables, wherein the copper wires or fiber optic cables include a cable reel that is anchored to the seafloor and the cable reel can control a length of the copper wires or fiber optic cables. The high-speed wireless communication may be facilitated from a vessel including but not limited to the drilling rig, another drilling rig, a boat, an airplane, a helicopter, unmanned aerial vehicle, submersible vehicle, satellite, land based office, building, tower, any other device that could facilitate wireless communications at high-speeds. The second control system is a primary or a back-up control system to the subsea device. It is further envisioned that the high-speed wireless communication is at a speed of at least 100 kilobits per second.

In some embodiments, a system for communicating with subsea devices may include a subsea device including a first control system in communication by a physical connection with a first control site (i.e., drilling rig); and a second control system in communication by a physical connection with a cable reel, wherein the cable reel is configured to facilitate underwater wireless communication with the subsea device; wherein the second control system has no physical connection with the first control site, and wherein the second control system is configured to facilitate high-speed wireless communication with the subsea device. Additionally, the second control system may include a sensor for detecting a loss of communication between the first control site and the subsea device, and wherein the second control system is configured to facilitate high-speed wireless communication with the subsea device when a loss of communication between the first control site and the subsea device is detected. The second control system may be a floatation device for maintaining a buoyancy and an independent power source for powering operations of the second control system and subsea device. Further the second control system may include a sensor for detecting a loss of communication between the first control site and the subsea device; and a floatation device for maintaining a buoyancy, wherein the second control system is deployed to the buoyancy when a loss of communication between the first control site and the subsea device is detected, and wherein the second control system is configured to facilitate high-speed wireless communication with the subsea device when a loss of communication between the first control site and the subsea device is detected. The subsea device is a blowout preventer stack, a subsea tree, a compression system, or an artificial lift system and the second control system may have a second power source for the blowout preventer stack, a subsea tree, a compression system, or an artificial lift system. The second power source may be one or more batteries, one or more solar panels, one or more wind power generators, one or more wave power generators, or any other power generating technology for the backup power. Further, the physical connection between the control system and the subsea device may include one or more multiplexed control cables connecting the first control site to one or more subsea control pods of the blowout preventer stack, the subsea tree, the compression system, or the artificial lift system. The one or more multiplexed control cables extend along an outer diameter of a drilling riser of the drilling rig. The second control system may be a buoy capable of floating on a surface of a body of water and the may be a motorized boat and can be can positioned remotely. Additionally, the buoy may be submersible and a motorized boat and can be positioned remotely. Furthermore, the physical connection between the second control system and the cable reel may include copper wires or fiber optic cables, wherein the cable reel is anchored to a seabed and the cable reel can control a length of the copper wires or fiber optic cables. The high-speed wireless communication may be facilitated from a vessel including the drilling rig, another drilling rig, a boat, an airplane, a helicopter, an unmanned aerial vehicle, submersible vehicle, satellite, or any other device that could facilitate wireless communications at high-speeds. The second control system is a primary or a back-up control system to the subsea device. It is further envisioned that the high-speed wireless communication is at a speed of at least 100 kilobits per second.

In some embodiments, a method for communicating with subsea devices, the method may include communicating with a subsea device with a first control system in communication by a physical connection with a first control site (i.e. drilling rig); communicating wirelessly at high-speeds to a second control system in communication by a physical connection with the subsea device; controlling the subsea device with the second control system, wherein the second control system has no physical connection with the first control site. The second control system may include a sensor for detecting a loss of communication between the first control site and the subsea device, and wherein the second control system wirelessly communicates at high-speeds with the subsea device when a loss of communication between the first control site and the subsea device is detected. Additionally, the method includes floating the second control system at a buoyancy. The second control system includes an independent power source for powering operations of the second control system and subsea device. Further, the second control system further may include a sensor for detecting a loss of communication between the first control site and the subsea device; and floating the second control system at a buoyancy, deploying the second control system to the buoyancy when a loss of communication between the first control site and the subsea device is detected, and wherein the second control system wirelessly communicates at high-speeds with the subsea device when a loss of communication between the first control site and the subsea device is detected. The subsea device is blowout preventer stack, a subsea tree, a compression system, or artificial lift system and the second control system may include a second power source for powering the blowout preventer stack, a subsea tree, a compression system, or an artificial lift system. The second power source may be one or more batteries, one or more solar panels, one or more wind power generator, one or more wave power generator, or any other power generating technology for the backup power. The method may further include connecting the control system and the subsea device including one or more multiplexed control cables connect the first control site to one or more subsea control pods of the blowout preventer stack, the subsea tree, the compression system, or the artificial lift system and extending the one or more multiplexed control cables along an outer diameter of a drilling riser of the drilling rig. The method my include floating the second control system with a buoy capable of floating on a surface of a body of water, wherein the buoy is a motorized boat and can be can positioned remotely. The buoy may be submersible and a motorized boat and can be positioned remotely. The method includes connecting the second control system and the subsea device with copper wires or fiber optic cables, wherein anchoring a cable reel to a seabed and the cable reel contorting a length of the copper wires or fiber optic cables. The wirelessly communicating at high-speeds may be facilitated from a vessel including the drilling rig, another drilling rig, a boat, an airplane, an unmanned aerial vehicle, a helicopter, submersible vehicle, satellite, land based office, building, tower, or any other device that could facilitate wireless communications at high-speeds. It is further envisioned that the high-speed wireless communication is at a speed of at least 100 kilobits per second.

In some embodiments, a method for communicating with subsea devices, the method may include communicating with a subsea device with a first control system in communication by a physical connection with a first control site (i.e. drilling rig); communicating wirelessly at high-speeds to a second control system in communication by a physical connection with the subsea device; controlling the subsea device with the second control system, wherein the second control system has no physical connection with the first control site. The second control system may include a sensor for detecting a loss of communication between the first control site and the subsea device, and wherein the second control system wirelessly communicating at high-speeds with the subsea device when a loss of communication between the first control site and the subsea device is detected. Additionally, the method includes floating the second control system at a buoyancy. The second control system includes an independent power source for powering operations of the second control system and subsea device. Further, the second control system further may include a sensor for detecting a loss of communication between the first control site and the subsea device; and floating the second control system at a buoyancy, deploying the second control system to the buoyancy when a loss of communication between the first control site and the subsea device is detected, and wherein the second control system wirelessly communicates at high-speeds with the subsea device when a loss of communication between the first control site and the subsea device is detected. The subsea device is blowout preventer stack, a subsea tree, a compression system, or artificial lift system and the second control system may include a second power source for powering the blowout preventer stack, a subsea tree, a compression system, or an artificial lift system. The second power source may be one or more batteries, one or more solar panels, one or more wind power generators, one or more wave power generators, or any other power generating technology for the backup power. The method may further include connecting the control system and the subsea device including one or more multiplexed control cables connecting the first control site to one or more subsea control pods of the blowout preventer stack, the subsea tree, the compression system, or the artificial lift system and extending the one or more multiplexed control cables along an outer diameter of a drilling riser of the drilling rig. The method my include floating the second control system with a buoy capable of floating on a surface of a body of water, wherein the buoy is a motorized boat and can be can positioned remotely. The buoy may be submersible and a motorized boat and can be positioned remotely. The method includes connecting the second control system and the subsea device with copper wires or fiber optic cables, wherein anchoring a cable reel to a seabed and the cable reel controlling a length of the copper wires, fiber optic cables, or other type of communications method including but not limited to pressure pulses. The wireless communication at high-speeds may be facilitated from a vessel including the drilling rig, another drilling rig, a boat, an airplane, an unmanned aerial vehicle, a helicopter, a submersible vehicle, a satellite, land based office, building, tower, or any other device that could facilitate wireless communications at high-speeds. It is further envisioned that the high-speed wireless communication is at a speed of at least 100 kilobits per second.

In some embodiments, a method for communicating with subsea devices, the method may include communicating with a subsea device with a first control system in communication by a physical connection with a first control site (i.e. drilling rig); communicating wirelessly at high-speeds to a second control system in communication by a physical connection with a cable reel, wherein the cable reel wirelessly communicates underwater with the subsea device; controlling the subsea device with the second control system, wherein the second control system has no physical connection with the first control site. The second control system may include detecting a loss of communication between the first control site and the subsea device, and wherein the second control system wirelessly communicates at high-speeds with the subsea device when a loss of communication between the first control site and the subsea device is detected. Additionally, the method includes floating the second control system at a buoyancy. The second control system includes an independent power source for powering operations of the second control system and subsea device. Further, the second control system further may include detecting a loss of communication between the first control site and the subsea device; and floating the second control system at a buoyancy, deploying the second control system to the buoyancy when a loss of communication between the first control site and the subsea device is detected, and wherein the second control system wirelessly communicates at high-speeds with the subsea device when a loss of communication between the first control site and the subsea device is detected. The subsea device is blowout preventer stack, a subsea tree, a compression system, or an artificial lift system and the second control system may include a second power source for powering the blowout preventer stack, a subsea tree, a compression system, or an artificial lift system. The second power source may be one or more batteries, one or more solar panels, one or more wind power generators, one or more wave power generators, or any other power generating technology for the backup power. The method may further include connecting the control system and the subsea device including one or more multiplexed control cables connect the first control site to one or more subsea control pods of the blowout preventer stack, the subsea tree, the compression system, or the artificial lift system and extending the one or more multiplexed control cables along an outer diameter of a drilling riser of the drilling rig. The method my include floating the second control system with a buoy capable of floating on a surface of a body of water, wherein the buoy is a motorized boat and can be can positioned remotely. The buoy may be submersible and a motorized boat and can be positioned remotely. The method includes connecting the second control system and the cable reel with copper wires or fiber optic cables, wherein anchoring the cable reel to a floor bed and the cable reel contorting a length of the copper wires or fiber optic cables. The wirelessly communicating at high-speeds may be facilitated from a vessel including the drilling rig, another drilling rig, a boat, an airplane, unmanned aerial vehicle, an helicopter, submersible vehicle, satellite, land based office, building, tower, or any other device that could facilitate wireless communications at high-speeds. It is further envisioned that the high-speed wireless communication is at a speed of at least 100 kilobits per second.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed is:

1. A system for communicating with subsea devices, the system comprising:
a subsea device;
a control site; and
a control system having no physical connection with the control site, wherein the control system is configured to facilitate high-speed wireless communication between the control site and the subsea device.

2. The system of claim 1, wherein the control site is a drilling rig, another drilling rig, a boat, an airplane, a helicopter, an unmanned aerial vehicle, a submersible vehicle, a satellite, a land based structure, an offshore structure, any combination thereof, or any device that could serve as a control site.

3. The system of claim 1, wherein the control system is a primary or a back-up control system to the subsea device.

4. The system of claim 1, wherein the control system comprises an independent power source for powering operations of the control system and the subsea device.

5. The system of claim 1, wherein the control system further comprises a sensor for detecting a loss of communication between the control site and the subsea device, and wherein the control system is configured to facilitate high-speed wireless communication with the subsea device when a loss of communication between the control site and the subsea device is detected.

6. The system of claim 1, where in the control system is connected to the subsea device wirelessly or with a physical connection.

7. A system for communicating with subsea devices, the system comprising:
a subsea device comprising a first control system in communication by a physical connection with a first control site capable of maintaining a physical connection with the first control system; and
a second control system in communication by a physical connection or wirelessly with the subsea device,
wherein the second control system has no physical connection with the first control site, and
wherein the second control system is configured to facilitate high-speed wireless communication with the subsea device.

8. The system of claim 7, wherein the second control system further comprises a sensor for detecting a loss of communication between the first control site and the subsea device, and wherein the second control system is configured to facilitate high-speed wireless communication with the subsea device when a loss of communication between the first control site and the subsea device is detected.

9. The system of claim 7, wherein the second control system comprises a floatation device for maintaining a buoyancy.

10. The system of claim 7, wherein the second control system comprises an independent power source for powering operations of the second control system and the subsea device.

11. The system of claim 7, the second control system comprising a buoy or other buoyant device capable of floating on a surface of a body of water and/or the buoy or other buoyant device is submersible.

12. The system of claim 7, wherein the physical connection between the second control system and the subsea device comprises a cable reel or apparatus anchored to a seabed and the cable reel or apparatus control a length of the physical connection.

13. The system of claim 7, wherein the second control system facilities the high-speed wireless communication from the first control site or a second control site to the subsea device, wherein the first control site or the second control site is a drilling rig, another drilling rig, a boat, an airplane, a helicopter, an unmanned aerial vehicle, a submersible vehicle, a satellite, a land based structure, an offshore structure, any combination thereof, or any other device that could facilitate wireless communications at high-speeds.

14. The system of claim 7, wherein the high-speed wireless communication is at a speed of at least 100 kilobits per second.

15. A method for communicating with subsea devices, the method comprising:
communicating with a subsea device with a first control system in communication by a physical connection with a first control site;
communicating wirelessly at high-speeds to a second control system in communication by a physical connection or wirelessly with the subsea device;
controlling the subsea device with the second control system, wherein the second control system has no physical connection with the first control site.

16. The method of claim 16, wherein the second control system further comprises detecting a loss of communication between the first control site and the subsea device, and wherein the second control system wirelessly communicates at high-speeds with the subsea device when a loss of communication between the first control site and the subsea device is detected.

17. The method of claim 16, further comprising floating the second control system at a buoyancy.

18. The method of claim 16, further comprising floating the second control system with a buoy or other buoyant device capable of floating on a surface of a body of water and/or submersing the buoy.

19. The method of claim 16, wherein connecting the second control system and the subsea device comprises a cable real or apparatus anchored to a seabed, and contorting a length of the physical connection with the cable real or apparatus.

20. The method of claim 16, wherein the wirelessly communicating at high-speeds is facilitated by the second control system from the first control site or a second control site to the subsea device, wherein the first control site or the second control site is a drilling rig, another drilling rig, a boat, an airplane, an helicopter, an unmanned aerial vehicle, a submersible vehicle, a satellite, or a land based structure, an offshore structure, any combination thereof, or any other device that could facilitate wireless communications at high-speeds.
